(19) United States
(12) Patent Application Publication
(10) Pub. No.: US 2006/0285239 A1
(43) Pub. Date: Dec. 21, 2006

(54) Moving image processing apparatus

(75) Inventor: Takamitsu Hanaoka, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/441,061

(22) Filed: May 26, 2006

(30) Foreign Application Priority Data
May 31, 2005 (JP) 2005-158603

(51) Int. Cl. G06F 9/44; G11B 5/02

(52) U.S. Cl. 360/55; 717/120

(57) ABSTRACT

Provided is a moving image processing apparatus that helps simplify the generation of an index image enabling easy identification of a series of moving images with the same program title that has been recorded according to the cyclic recording. With respect to the moving images with the same program title that have been recorded according to the cyclic recording, a still image selected from a reference moving image, which is one of the moving images, is equally set as an index image of each of the moving images.

This application is based on Japanese Patent Application No. 2005-158603 filed on May 31, 2005, the contents of which are hereby incorporated by reference.

### BACKGROUND OF THE INVENTION

1. Field of the Invention

The present invention relates to a moving image processing apparatus, such as a HDD (hard disk drive) recorder or a DVD (digital versatile disk) recorder, that records data on a moving image on a recording medium, reads the recorded data, and playbacks the moving image.

2. Description of Related Art

Ordinary moving image processing apparatuses record an analog or digital broadcast program on a recording medium such as a hard disk or a DVD as moving image data according to the scheduled recording or recording operations, and, at a later time, sends the moving image data thus recorded to a monitor according to the playback operations and makes the monitor display the program. Since a large number of moving images are often recorded on the recording medium, the moving image processing apparatuses have, from the viewpoint of making it easy to search the recording medium for a desired moving image, the function of setting still images one from each of the recorded moving images as an index image (a so-called thumbnail image) and displaying a list of index images thus set.

Conventionally, an index image is generally set as follows. A still image at the head of a moving image is automatically set as an index image, or an appropriate still image is selected while playing back a moving image in edit mode and is then set as an index image.

In the former case, a still image at the head of a moving image is automatically set as an index image, offering simplicity. On the other hand, the index image thus set (the still image at the head of the moving image) is often far from a representative of the moving image in which it is included, and thus cannot be used to search for a desired moving image at all. For example, a moving image that has been recorded according to the scheduled recording often begins with a commercial image or an image of one scene of a main part of a program and then proceeds to an image including a title of the program.

In the latter case, since a still image appropriate to the contents of a moving image is set as an index image, it is sufficiently applicable to search for a desired moving image. On the other hand, however, it is necessary to perform settings one for each of the moving images in edit mode, which undesirably requires much time and trouble.

In view of the above-described conventional ordinary moving image processing apparatuses, a moving image processing apparatus is disclosed in JP-A-2004-222268 that generates index images one for each of a series of moving images, in particular, the moving images with the same program title to be sequentially recorded at a given cycle according to the scheduled recording (hereinafter may be referred to as the “cyclic recording”). This moving image processing apparatus selects an appropriate still image in edit mode from one of the moving images that have been recorded according to the cyclic recording and then sets it as an index image of the moving image, and, at the same time, stores position information (time information) of the still image in the moving image. For other moving images including a moving image newly recorded at the same cycle, still images are supposed to be automatically selected one from each of the moving images at the same position as indicated by the position information and then set as index images thereof.

In such a moving image processing apparatus, index images of a series of moving images that has been recorded according to the cyclic recording are set as follows. With respect to one of the moving images, an appropriate still image at a position a predetermined period forward from a head thereof is set as an index image thereof in edit mode. With respect to each of the other moving images, a still image at a position a predetermined period forward from a head thereof is automatically set as an index image thereof. This eliminates the need to set index images one for each of the moving images in edit mode, offering simplicity. Moreover, if all the moving images have the same program scene construction, that is, if a title of the program, a main part of the program, and commercials, for example, appear at the same time intervals in each moving image, index images of the moving images are appropriately set. Thus, it can be supposedly expected to offer easy identification when searching for a series of moving images by displaying a list of index images.

However, even when moving images are of the same series and have the same program title, the program scene constructions thereof are not always identical to each other. In actuality, a title of the program, a main part of the program, and commercials, for example, often appear at slightly different time intervals in each moving image. Since the above-described moving image processing apparatus fundamentally relies on the assumption that a series of moving images has the same scene construction, once this assumption is undermined, index images (still images) of the moving images other than one moving image whose index image has been set in edit mode are far from representatives of the moving images including them. This makes it difficult, when searching for a moving image by displaying a list of index images, to identify even those belonging to the same series.

### SUMMARY OF THE INVENTION

In view of the above problems, it is an object of the present invention to provide a moving image processing apparatus that helps simplify the generation of an index image enabling easy identification of a series of moving images with the same program title that has been recorded according to the cyclic recording.

To achieve the above object, according to the present invention, a moving image processing apparatus that generates index images one for each of moving images sequentially recorded at a given cycle is provided with: a reference moving image specifying portion that specifies one moving image used as a reference moving image; a reference index image setting portion that selects a still image from the reference moving image specified by the reference moving image specifying portion and sets the still image as an index image of the reference moving image; a related moving image specifying portion that specifies a moving image recorded at the same cycle as a cycle at which the reference moving image is recorded; and a related index image setting portion that chooses the still image set by the reference index image setting portion and sets the still image as an index image of a related moving image specified by the related moving image specifying portion.

With this structure, with respect to a series of moving images with the same program title that has been recorded according to the cyclic recording, a still image selected from a reference moving image, which is one of the moving images, is equally set as an index image of each of the moving images. That is, index images of a series of moving images are made identical to each other. Furthermore, the setting of a index image does not require any special settings for each of the moving images in edit mode, offering simplicity.

From a practical standpoint, preferably, the reference moving image is the first recorded moving image of the moving images recorded at the same cycle.

Here, assuming that the moving images of the same series are continuously recorded according to the cyclic recording, it is preferable that the related moving image specifying portion and the related index image setting portion are made to operate every time the related moving image is newly recorded.

According to a moving image processing apparatus of the present invention, index images of a series of moving images are made identical to each other. This makes it possible, when searching a desired moving image by displaying a list of index images, to easily identify a series of moving images, because their index images are identical to each other.

### BRIEF DESCRIPTION OF THE DRAWINGS

FIG. 1 is a block diagram showing the schematic structure of the HDD recorder as one embodiment of the moving image processing apparatus of the present invention.

FIG. 2 is a flowchart showing how the cyclic recording is performed in the moving image processing apparatus of FIG. 1.

FIG. 3 is a flowchart showing how a reference moving image is expressly specified with respect to the moving images that have been recorded according to the cyclic recording by the moving image processing apparatus of FIG. 1.

### DETAILED DESCRIPTION OF PREFERRED EMBODIMENTS

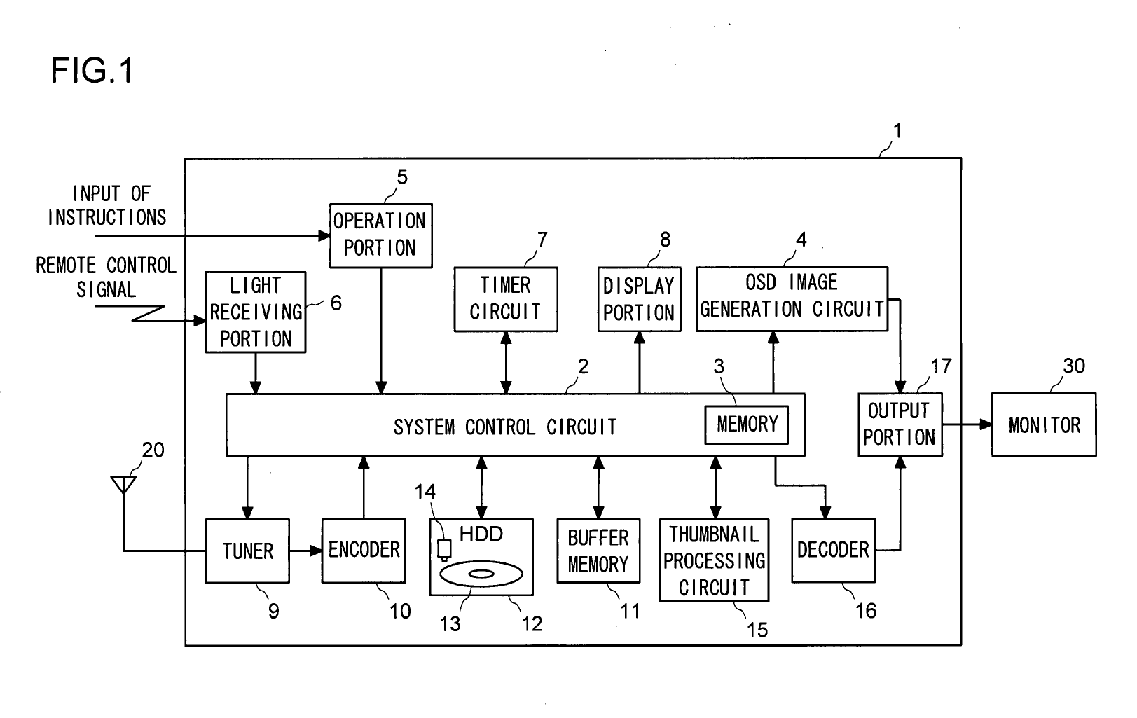

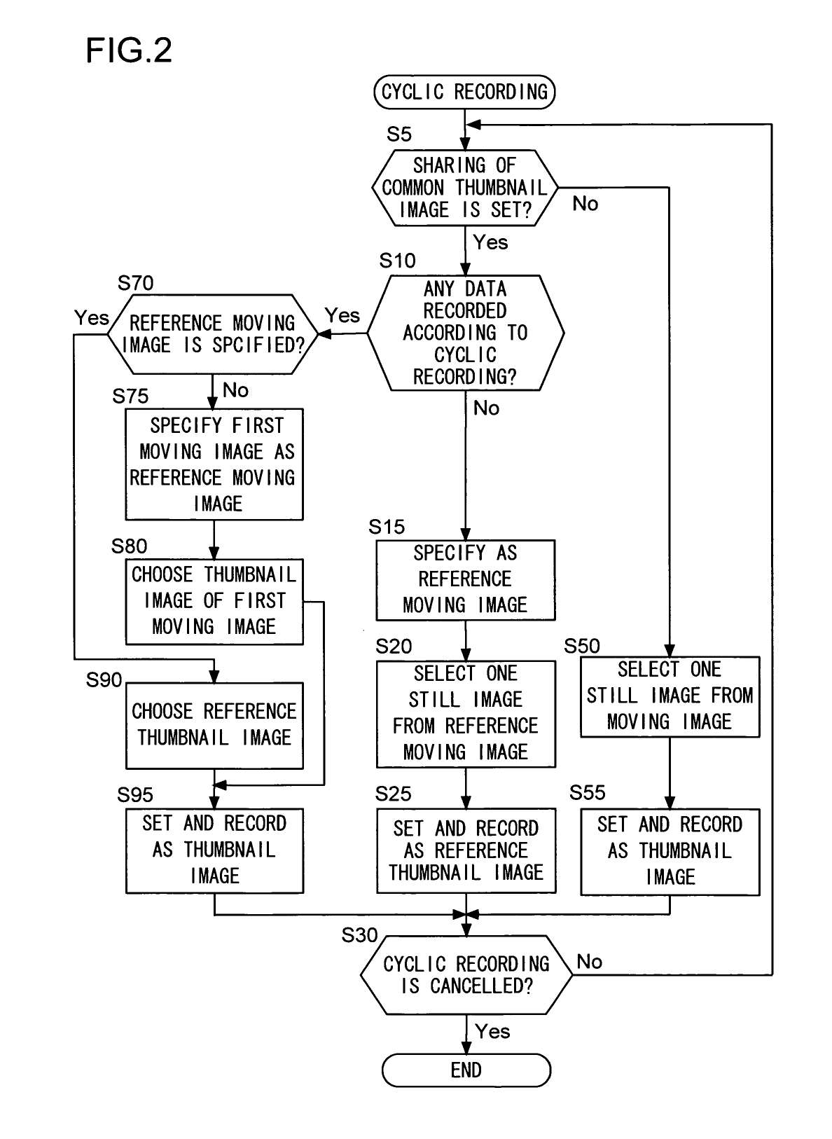

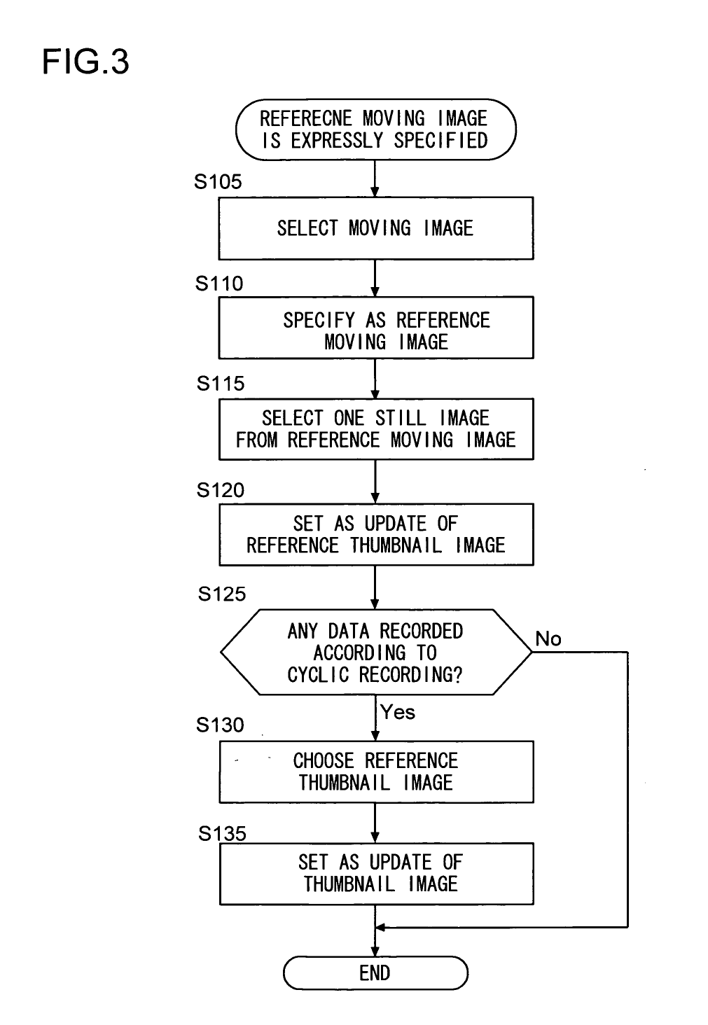

Hereinafter, one embodiment of the moving image processing apparatus of the present invention will be described in detail with reference to the accompanying drawings. FIG. 1 is a block diagram showing the schematic structure of the HDD recorder as one embodiment of the moving image processing apparatus of the present invention. FIG. 2 is a flowchart showing how the cyclic recording is performed in the HDD recorder. FIG. 3 is a flowchart showing how a reference moving image is expressly specified with respect to the moving images that have been recorded according to the cyclic recording by the HDD recorder.

As shown in FIG. 1, a moving image processing apparatus 1 of the present embodiment is a HDD recorder that adopts a hard disk 13 as a recording medium, and has the basic function of recording a received program to the hard disk 13 as moving image data according to the scheduled recording or recording operations, and, at a later time, sending the moving image data thus recorded to a monitor 30 according to the playback operations and making the monitor 30 display the program. In addition to this, the moving image processing apparatus 1 has the function of displaying, at the time of play back, a list of index images (hereinafter may be referred to as “thumbnail images”) of the moving images recorded on the hard disk 13.

The main components of this moving image processing apparatus 1 are a system control circuit 2, an OSD (on-screen display) image generation circuit 4, an operation portion 5, a light receiving portion 6, a timer circuit 7, a display portion 8, a tuner 9, an MPEG (Moving Picture Experts Group) encoder 10, a buffer memory 11, a hard disk drive (HDD) 12, a thumbnail processing circuit 15, an MPEG decoder 16, and an output portion 17. The system control circuit 2 includes a memory 3. The HDD 12 includes the hard disk 13 and an information recording head 14. An antenna 20 is connected to the tuner 9. The monitor 30 such as a television or a display-only monitor is connected to the output portion 17.

The system control circuit 2 controls, while performing signal input/output, the entire operations of the moving image processing apparatus 1 such as recording of received moving image data (including audio data), reading of the data thus recorded, and generating and reading of thumbnail image data. The above-described control is performed based on a program previously stored in the memory 3, for example.

On the detection of instructions from the user, the system control circuit 2 generates a signal for making the monitor 30 display a predetermined screen. Such a screen is, for example, a screen for settings of the cyclic recording or scheduled recording, a screen on which a moving image based on the recorded moving image data is played back, or a screen on which a list of thumbnail images of the moving images is displayed.

The OSD image generation circuit 4 generates a signal for displaying a message image based on the instructions from the operation portion 5 or the instructions obtained from a remote control via the light receiving portion 6, or based on the conditions previously determined in the system control circuit 2. This message image is an image in which, for example, channels, a recording setting screen, a list of thumbnail images, or volume levels are displayed, and is different from a moving image from the HDD 13. The OSD image generation circuit 4 generates a signal for such a message image, and outputs it to the output portion 17. When this signal is outputted, a message image represented by the signal is displayed on the monitor 30.

The operation portion 5 detects instructions inputted by the user. The operation portion 5 is, for example, an input button provided on a front panel of the moving image processing apparatus 1, but not limited thereto. On the detection of the instructions, a signal for performing a process corresponding to the instructions is generated. This signal is outputted to the system control circuit 2.

The light receiving portion 6 receives a remote control signal transmitted from the remote control. This signal is outputted to the system control circuit 2.

The timer circuit 7 measures time in the moving image processing apparatus 1. Although the timer circuit 7 operates with electric power fed from the outside, it can keep operating for a previously set time even when there is a temporary power failure. The timer circuit 7 outputs time data to the system control circuit 2, and receives a control signal from the system control circuit 2. The time measured by the timer circuit 7 is corrected based on the signal from the system control circuit 2.

The display portion 8 displays information on the moving image processing apparatus 1. This information includes time, receiving channel, counter, recording/playback mode and other items. The display portion 8 is, for example, an LCD (liquid crystal display) or an LED (light emitting diode) provided on the front panel of the moving image processing apparatus 1, but not limited thereto.

The tuner 9 receives moving image data of an analog or digital broadcast program via the antenna 20. The data signal received by the tuner 9 is outputted to the MPEG encoder 10. Additionally, the tuner 9 can switch receiving channels based on the signal from the system control circuit 2.

The MPEG encoder 10 converts an analog signal received from the tuner 9 to an MPEG encoded digital signal, and then outputs it to the system control circuit 2.

Based on the signal from the system control circuit 2, the HDD 12 writes the MPEG encoded data to the hard disk 13 with the information recording head 14, or reads the data stored in the hard disk 13 therefrom. The hard disk 13 used here has a management data region and an object data region as its data recording region. In the object data region, object data representing a moving image object itself is recorded. On the other hand, in the management data region, management data for managing data on the moving images recorded on the hard disk 13 is recorded. The management data includes data on a data system of each moving image object, data on an attribute such as recording channel or date and time of recording, or data on a thumbnail image.

The buffer memory 111 temporarily records the moving image data received by the moving image processing apparatus 1 based on the signal from the system control circuit 2. The data thus temporarily recorded is sequentially sent to the HDD 12.

Based on the signal from the system control circuit 2, the thumbnail processing circuit 15 extracts data on one still image from the data on a moving image corresponding to one program, and then sends the data thus extracted to the HDD 12 as image data on a thumbnail image. The data thus sent is recorded in the management data region of the hard disk 13. Here, the data is recorded in the form of object data on one still image in a moving image or in the form of an address pointing to a location of one still image in a moving image. Additionally, the thumbnail processing circuit 15 can receive data recorded on the hard disk 13 from the HDD 12 based on the signal from the system control circuit 2. In that case, the thumbnail processing circuit 15 processes data on a thumbnail image based on the data thus received, and then re-sends the data thus processed to the HDD 12. The data thus re-sent is recorded as an update in the management data region of the hard disk 13.

The MPEG decoder 16 decodes the MPEG encoded data read from the HDD 12, and then outputs it to the output portion 17.

The output portion 17 outputs the signal from the OSD image generation circuit 4 and the signal from the MPEG decoder 16 to the monitor 30. As a result, a message image generated by the OSD image generation circuit 4 and a moving image read from the HDD 12 are displayed on the monitor 30. Here, a list of thumbnail images displayed on the monitor 30 via the OSD image generation circuit 4 is generated based on the data on a thumbnail image read from the management data region of the hard disk 13.

Next, the setting of the scheduled recording including the cyclic recording performed by the moving image processing apparatus 1 will be described. When scheduled recording setting instructions are received from the operation portion 5 or the remote control, the system control circuit 2 makes the OSD image generation circuit 4 display a recording setting screen on the monitor 30. The recording setting screen includes not only items pertinent to recording itself, such as channel of a program to be recorded, recording start time, recording finish time, date of recording, and “every week” or “every day” recording, but also a check box asking whether to share a common thumbnail image. The sharing of a common thumbnail image will be described in detail below.

Here, in order to perform the cyclic recording of a series of programs transmitted at a given cycle, channel of the program, recoding start time, recording finish time, and “every week” or “every day” recording corresponding to the cyclic recording, for example, are set mainly by the operation of the remote control. Furthermore, in order to enable the sharing of a common thumbnail image among a series of moving images with the same program title to be recorded according to the cyclic recording, a check box asking whether to share a common thumbnail image is checked. The above-described setting for enabling the sharing of a common thumbnail image may be performed at the initial setting stage before the cyclic recording of the program is actually started; in practice, however, it may be performed after the cyclic recording has been performed several times and thus several moving images have been recorded.

When one-time only scheduled recording is performed, channel of the program to be recorded, recording start time, recording finish time, and date of recording, for example, are set mainly by the operation of the remote control.

The input setting data on such cyclic recording or scheduled recording is stored in the memory 3. The data on the cyclic recording remains stored in the memory 3 until the setting of the cyclic recording is cancelled. On the other hand, the data on the one-time only scheduled recording is cleared when the scheduled recording is completed.

Next, how the cyclic recording is performed in the moving image processing apparatus 1 will be described with reference to FIG. 2. Based on the data on the cyclic recording stored in the memory 3, the system control circuit 2 starts to receive moving image data of a predetermined channel at a predetermined start time from the tuner 9 via the MPEG encoder 10. The moving image data thus received is temporarily stored in the buffer memory 11, and is then sequentially sent to the HDD 12. The data thus sent is written to the hard disk 13 with the information recording head 14, and is recorded thereon.

At this time, first of all, it is judged at step S5 whether or not the sharing of a common thumbnail image is set in the data on the cyclic recording. If the sharing of a common thumbnail image is found to be set, the procedure proceeds to step S110.

At step S10, it is judged whether or not there is any moving image data that has been recorded according to the same cyclic recording in the hard disk 13. If no moving image data that has been recorded according to the same cyclic recording is found there, that is, if this moving image is the first moving image that has been recorded according to the cyclic recording, the procedure proceeds to step S15.

At step S15, this first moving image is specified as a reference moving image, and this specification information is stored in the memory 3. Subsequently, at step S20, the thumbnail processing circuit 15 extracts and selects data on a still image at the head of the moving image from the moving image data, and then sends the data thus selected to the buffer memory 11 as image data on a thumbnail image of the moving image. Then, the procedure proceeds to step S25.

Next, at step S25, the buffer memory 11 sends the data received from the thumbnail processing circuit 15 to the HDD 12, along with the object data of the moving image. In the hard disk 13, the data received from the thumbnail processing circuit 15 is recorded in the management data region as a thumbnail image of the moving image and eventually as a reference thumbnail image. Then, the procedure proceeds to step S30.

On the other hand, if the sharing of a common thumbnail image is found not to be set at step S5, the procedure proceeds to step S50, and the thumbnail processing circuit 15 extracts and selects data on a still image at the head of the moving image from the moving image data thereof, and then sends, to the buffer memory 11, the data thus selected as image data on a thumbnail image of the moving image. Then, the procedure proceeds to step S55.

Next, at step S55, the buffer memory 11 sends the data received from the thumbnail processing circuit 15 to the HDD 12, along with the object data of the moving image. In the hard disk 13, the data received from the thumbnail processing circuit 15 is recorded in the management data region as a thumbnail image of the moving image. Then, the procedure proceeds to step S30.

On the other hand, if moving image data that has been recorded according to the cyclic recording is found at step S10, the procedure proceeds to step S70, and it is judged whether or not a reference moving image is specified. Specifically, it is judged whether or not specification information on a reference moving image is stored in the memory 3. If a reference moving image is found not to be specified, the procedure proceeds to step S75. On the other hand, if a reference moving image is found to be specified, the procedure proceeds to step S90.

At step S75, a thumbnail image of the moving image is set as follows. First, the first recorded moving image of the moving images that have been recorded according to the cyclic recording is specified as a reference moving image, and this specification information is stored in the memory 3. Subsequently, at step S80, the thumbnail processing circuit 15 chooses data on a thumbnail image of the moving image specified as a reference moving image, namely, data on a thumbnail image of the first recorded moving image, and receives it from the HDD 12. The data thus received is sent to the buffer memory 11 as image data on a thumbnail image of the moving image. Then, the procedure proceeds to step S95.

Next, at step S95, the buffer memory 11 sends the data received from the thumbnail processing circuit 15 to the HDD 12, along with the object data of the moving image. In the hard disk 13, the data received from the thumbnail processing circuit 15 is recorded in the management data region as a thumbnail image of the moving image. Then, the procedure proceeds to step S30.

Here, with respect to the first recorded moving image of the moving images that have been recorded according to the cyclic recording, namely, the moving image specified as a reference moving image, the data derived from the first recorded moving image itself and received from the thumbnail processing circuit 15 is recorded as an update of a thumbnail image of the moving image and eventually as an update of a reference thumbnail image. With respect to all the other moving images that have been recorded according to the cyclic recording except for the first recorded moving image, the data on the reference thumbnail image is recorded as an update of a thumbnail image of each of the moving images.

At step S70, if a reference moving image is found to be specified, the procedure proceeds to step S90, and the thumbnail processing circuit 15 chooses data on a reference thumbnail image of the moving image specified as a reference moving image, and receives it from the HDD 12. The data thus received is sent to the buffer memory 11 as image data on a thumbnail image of the moving image. Then, the procedure proceeds to step S95.

Next, at step S95, the buffer memory 11 sends the data received from the thumbnail processing circuit 15 to the HDD 12, along with the object data of the moving image. In the hard disk 13, the data received from the thumbnail processing circuit 15 is recorded in the management data region as a thumbnail image of the moving image. Then, the procedure proceeds to step S30.

At step S30, it is judged whether or not the cyclic recording is cancelled. If the cyclic recording is found not to be cancelled, the procedure goes back to step S5, and the above-described processes are performed. If the cyclic recording is found to be cancelled, the procedure is ended.

With respect to a series of moving images with the same program title that has been recorded according to the cyclic recording, irrespective of whether a moving image has already been recorded or is newly recorded according to the cyclic recording, a still image selected from the first recorded moving image of the moving images is equally set as a thumbnail image of each moving image and is recorded as such. That is, thumbnail images of a series of moving images are made identical to each other. Furthermore, the setting of a thumbnail image does not require any special settings for each of the moving images in edit mode, offering simplicity.

When the system control circuit 2 is given instructions from the operation portion 5 or the remote control to generate a list of thumbnail images of the recorded moving images, the data on a thumbnail image of each of the moving images is read from the hard disk 13 by the HDD 12, and then a list of thumbnail images based on the data thus read is displayed on the monitor 30 via the OSD image generation circuit 4 and the output portion 17. In this list of thumbnail images, with respect to a series of moving images with the same program title that has been recorded according to the cyclic recording, the thumbnail images are made identical to each other. The reason is as follows: with respect to the first recorded moving image of the moving images that have been recorded according to the cyclic recording, that is, a reference moving image, a still image at the head thereof is displayed; with respect to the other moving images, the still image at the head of the reference moving image is assigned thereto, that is, the still image at the head of the reference moving image is displayed. This makes it possible, when searching a desired moving image by displaying a list of thumbnail images, to easily identify a series of moving images, because their thumbnail images are identical to each other.

Next, how a reference moving image is expressly specified with respect to the moving images that have been recorded according to the cyclic recording by the moving image processing apparatus 1 will be described with reference to FIG. 3. At step S105, a moving image used as a reference moving image is selected. This selection can be performed by using a screen on which a list of thumbnail images of the recorded moving images are displayed or a screen on which a list of titles are displayed.

Next, at step S110, the moving image thus selected is specified as a reference moving image, and this specification information is stored in the memory 3 as an update. Subsequently, at step S115, the thumbnail processing circuit 15 extracts and receives, from the HDD 12, data on a still image at the head of the moving image specified as a reference moving image, and sends the data thus received as image data on a thumbnail image of the moving image to the buffer memory 11. Then, the procedure proceeds to step S120.

In the embodiment described above, data on a still image at the head of the specified moving image is automatically extracted at step S115; however, it is also possible, for example, to select an appropriate still image while playing back the moving image in edit mode, and then send the data thus selected to the buffer memory 11 as image data on a thumbnail image of the moving image.

Next, at step S120, the buffer memory 11 sends the data received from the thumbnail processing circuit 15 to the HDD 12. In the hard disk 13, the data received from the thumbnail processing circuit 15 is recorded in the management data region as an update of a thumbnail image of the moving image and eventually as an update of a reference thumbnail image.

Next, at step S125, it is judged whether or not there is any moving image data that has been recorded according to the same cyclic recording in the hard disk 13. If moving image data that has been recorded at the same cyclic recording is found there, the procedure proceeds to step S130. On the other hand, if there is none, the procedure is ended.

At step S130, with respect to all the other moving images that have been recorded according to the cyclic recording except for the moving image specified at step S110, the data on a reference thumbnail image recorded as an update is selected. At step S135, the data thus selected is recorded in the management data region of the hard disk 13 as an update of a thumbnail image of each moving image, and then the procedure is ended.

By expressly specifying a reference moving image in the manner as described above, it is possible to choose a still image used as a reference thumbnail image with respect to the moving images that have been recorded according to the cyclic recording from a moving image different from the first recorded moving image. Also in this case, thumbnail images of the moving images are made identical to each other. Furthermore, when another moving image is newly recorded according to the same cyclic recording, a reference thumbnail image of the expressly specified reference moving image is chosen and recorded as a thumbnail image of the newly recorded moving image in accordance with steps S70, S90, and S95 of FIG. 2 until the cyclic recording is cancelled. As a result, thumbnail images of a series of moving images are made identical to each other. What's more, the setting of a thumbnail image does not require any special settings for each of the moving images in edit mode other than the setting of a reference moving image, offering simplicity.

In this list of thumbnail images, with respect to a series of moving images with the same program title that has been recorded according to the cyclic recording, the thumbnail images are made identical to each other. The reason is as follows: with respect to a moving image expressly specified as a reference moving image, one still image selected therefrom is displayed; with respect to the other moving images, the one still image of the reference moving image is assigned thereto, that is, the one still image of the reference moving image is displayed. This makes it possible, when searching a desired moving image by displaying a list of thumbnail images, to easily identify a series of moving images, because their thumbnail images are identical to each other.

It is to be understood that the present invention is not limited in any way by the embodiment thereof described above, because the above embodiment is merely an example of how the invention can be implemented. The embodiment described above deals with a HDD recorder as a moving image processing apparatus 1. It is to be understood, however, the present invention is applicable also to a DVD recorder that adopts a DVD as a recording medium. In that case, however, there are restrictions on data to be recorded in a data recording region of the DVD, depending on a standard with which a DVD recorder complies. For example, in a DVD recorder that complies with the DVD-VR standard, information data representing each of the moving images with the same program title that have been recorded according to the cyclic recording is recorded in the IT_TEXT table in the ORG_PGI table constituting the ORG_PGCI table in an IFO file provided for each moving image, and information data representing a thumbnail image of each of the moving images is recorded in the ORG_PGI table constituting the ORG_PGCI table in an IFO file provided for each moving image.

Obviously, many modifications and variations of the present invention are possible in light of the above teachings. It is therefore to be understood that within the scope of the appended claims, the invention may be practiced other than as specifically described.

What is claimed is:

1. A moving image processing apparatus that generates index images one for each of moving images sequentially recorded at a given cycle, the image processing apparatus comprising:
a reference moving image specifying portion that specifies one moving image used as a reference moving image;
a reference index image setting portion that selects a still image from the reference moving image specified by the reference moving image specifying portion and sets the still image as an index image of the reference moving image;
a related moving image specifying portion that specifies a moving image recorded at a same cycle as a cycle at which the reference moving image is recorded; and
a related index image setting portion that chooses the still image set by the reference index image setting portion and sets the still image as an index image of a related moving image specified by the related moving image specifying portion.

2. The moving image processing apparatus of claim 1,
wherein the reference moving image is a first recorded moving image of moving images recorded at a same cycle.

3. The moving image processing apparatus of claim 1,
wherein the related moving image specifying portion and the related index image setting portion are made to operate every time the related moving image is newly recorded.
